(19) United States
(12) Patent Application Publication
(10) Pub. No.: US 2004/0028337 A1
(43) Pub. Date: Feb. 12, 2004

(54) Optical mode coupling devices and an optical switch matrix based thereon

(76) Inventors: Ilya Vorobeichik, Haifa (IL); Edvardas Narevicius, Nesher (IL); Nimrod Moiseyev, Haifa (IL); Meir Orenstein, Haifa (IL)

Correspondence Address: Eitan Pearl Latzer & Cohen Zedek, Suite 1001, 10 Rockefeller Plaza, New York, NY, 10020, US

(21) Appl. No.: 10/416,583

(22) PCT Filed: Nov. 14, 2001
(86) PCT No.: PCT/IL01/01052

(51) Int. Cl. G02B 6/26

(52) U.S. Cl. 385/50; 385/28

(57) ABSTRACT

The invention is a waveguide structure (10) that includes two waveguides (90, 94) flanking a coupling region (92) whose effective refractive index is less than those of the waveguides. Outboard of the waveguides are bounding regions (88, 96) whose effective refractive indices decrease inwards adiabatically at the proximal and distal ends of the bounding regions. The waveguides are coupled optically by periodic perturbations of the waveguide geometry, or by reversible uniform or periodic perturbations of the effective refractive indices. In an optical switch matrix based on the waveguide structure, all the waveguides are straight and parallel. A second aspect of the invention is a directional coupler comprising mechanisms for reversibly and quasiperiodically perturbing the effective refractive indices of the waveguides. The respective envelope functions vary monotonically in opposite senses. Light propagating in one waveguide, in the direction in which that waveguide's envelope function increases, is coupled into the other waveguide.

### FIELD AND BACKGROUND OF THE INVENTION

The present invention relates to optical communications devices and, more particularly, to optical couplers.

An optical coupler is a device for exchanging light between two optical waveguides. An optical waveguide is a device for transmitting light over long distances with low losses. It consists of a linearly extended guide portion, having a relatively high index of refraction, encased in a cladding having a lower index of refraction. Light is confined to the guide portion by total internal reflection. Common examples of optical waveguides include planar waveguide structures, which, for the transmission of infrared light, often are made from semiconductors in the same way as integrated circuits, and optical fibers. In an optical fiber, the guide portion conventionally is called a “core”.

A directional coupler, in particular, consists of two parallel waveguides in close proximity to each other. The theory of directional couplers is described in D. Marcuse, Theory of Dielectric Optical Waveguides, Academic Press, Second Edition, 1991, Chapter 6, which is incorporated by reference for all purposes as if fully set forth herein. Two identical waveguides, far apart from each other, have identical propagation modes, with identical propagation constants. As the two waveguides are brought closer to each other, pairs of corresponding modes become coupled. The solutions of Maxwell's equations are, to a close approximation, sums (even symmetry) and differences (odd symmetry) of the corresponding uncoupled modes, each solution having its own propagation constant that is slightly different from the propagation constants of the corresponding uncoupled modes. Monochromatic light entering a directional coupler via the guide portion of one of the waveguides in one uncoupled mode thus is a linear combination of two coupled modes. Therefore, this light is exchanged between the guide portions of the two waveguides. After propagating through the directional coupler for a distance called the “beat length”, the light has been transferred entirely to the guide portion of the other waveguide. Of course, if the directional coupler is longer than the beat length, the light returns to the guide portion of the first waveguide. The beat length is inversely proportional to the difference between the coupled propagation constants. Specifically, the beat length L=π/(βₑ-βₒ), where βₑ is the propagation constant of the coupled even mode and βₒ is the propagation constant of the coupled odd mode. These propagation constants are functions of the indices of refraction of the guide portions and of the intervening optical medium, and of the wavelength of the light.

The closer the guide portions are to each other, the larger the difference between the coupled propagation constants. In practical optical couplers of this type, in order to keep the beat length, and hence the length of the device, on the order of centimeters, the distance between the coupled guide portions often must be on the order of micrometers. This dimensional restriction increases the cost and complexity of the couplers.

Vorobeichik et al., in U.S. Pat. No. 6,088,495, which is incorporated by reference for all purposes as if fully set forth herein, describe a directional coupler in which the separately propagating modes in the two waveguides are coupled via one or more higher order mode that, rather than being localized to the guide portions of the waveguides, are spread over both the waveguides and the optical medium between the waveguides. Coupling is achieved by periodic perturbation of the indices of refraction of the waveguides.

### SUMMARY OF THE INVENTION

The directional coupler described by Vorobeichik et al. is based on coupled optical fibers. A first aspect of the present invention is a similar directional coupler that is based on a planar waveguide structure.

The optical mode coupling, that is achieved by uniform periodic modulation or perturbation of the effective refractive indices of the waveguides, is sensitive to minor variations of various parameters, such as modulation period, wavelength, and coupling strength ratio. A second aspect of the present invention is a directional coupler, with adiabatic optical mode coupling, in which the modulation strength is not uniform in the propagation direction, and whose performance is relatively insensitive to minor variations of these parameters.

According to the present invention there is provided a waveguide structure including: (a) a first waveguide, having a proximal end, and having a first waveguide effective index of refraction \overline{n}₁; (b) a second waveguide, substantially parallel to the first waveguide, having a proximal end, and having a second waveguide effective index of refraction \overline{n}₂; (c) a coupling region, situated between the waveguides, having a coupling region effective index of refraction \overline{n}₃ that is less than \overline{n}₁ and that also is less than \overline{n}₂; (d) a first bounding region, the first waveguide being situated between the first bounding region and the coupling region, the first bounding region having a proximal end adjacent to the proximal end of the first waveguide, the first bounding region having a first bounding region effective index of refraction that decreases adiabatically, in a direction substantially parallel to the waveguides, from a value, at the proximal end of the first bounding region, that is between \overline{n}₁ and \overline{n}₃, to an intermediate value, in a switching section of the first bounding region, that is less than \overline{n}₃; and (e) a second bounding region, the second waveguide being situated between the second bounding region and the coupling region, the second bounding region having a proximal end adjacent to the proximal end of the second waveguide, the second bounding region having a second bounding region effective index of refraction that decreases adiabatically, in the substantially parallel direction, from a value, at the proximal end of the second bounding region, that is between \overline{n}₂ and \overline{n}₃, to an intermediate value, in a switching section of the second bounding region, that is less than \overline{n}₃.

According to the present invention there is provided an optical switch matrix, for switching optical signals from a first number of input waveguides to a second number of output waveguides, a larger of the two numbers being greater than 2, the optical switch matrix including: (a) a plurality of switch waveguides, equal in number to the larger of the two numbers, each switch waveguide being optically coupled to at least one of a respective input waveguide and a respective output waveguide, all the switch waveguides being substantially straight and parallel.

According to the present invention there is provided a directional coupler, including: (a) a first waveguide having a first effective index of refraction; (b) a second waveguide, substantially parallel to the first waveguide and having a second effective index of refraction; (c) a first mechanism for reversibly inducing a first quasiperiodic perturbation in the first effective index of refraction; and (d) a second mechanism for reversibly inducing a second quasiperiodic perturbation in the second effective index of refraction; wherein the first quasiperiodic perturbation has a first envelope function that varies monotonically along the first waveguide, and wherein the second quasiperiodic perturbation has a second envelope function that varies monotonically along the second waveguide in a sense opposite to the variation of the first envelope function.

According to the present invention there is provided a method for diverting a least a portion of electromagnetic energy, that propagates in a certain direction via a first waveguide, to a second waveguide that is substantially parallel to the first waveguide, including the steps of: (a) inducing a first quasiperiodic perturbation in an effective index of refraction of the first waveguide, the first perturbation having an envelope function that varies monotonically in the propagation direction; and (b) inducing a second quasiperiodic perturbation in an effective index of refraction of the second waveguide, the second perturbation having an envelope function that varies monotonically in the propagation direction in a sense opposite to the variation of the envelope function of the first perturbation.

The devices of the present invention are intended for the manipulation of electromagnetic energy generally, but more particularly infrared light of the frequencies typically used in optical communication. The effective refractive indices defined herein are with respect to a target monochromatic frequency, for example, 193.5 THz, the frequency of the infrared light, commonly used in optical communication, that has a free space wavelength of 1550 nm.

FIG. 1 illustrates the effective refractive index structure of a planar waveguide structure 10 of the present invention Waveguide structure 10 is based on two straight, parallel waveguides 12 and 14, on either side of a coupling region 16. Left waveguide 12 has an effective index of refraction \overline{n}₁. Right waveguide 14 has an effective index of refraction \overline{n}₂. Coupling region 16 has an effective index of refraction \overline{n}₃. The only obligatory constraints on \overline{n}₁, \overline{n}₂ and \overline{n}₃ are that \overline{n}₃<\overline{n}₁ and \overline{n}₃<\overline{n}₂; \overline{n}₂ may be less than, equal to or greater than \overline{n}₁. Proximal ends 18, 20 and 22 of waveguides 12 and 14 and of coupling region 16 are mutually adjacent. Similarly, distal ends 24, 26 and 28 of waveguides 12 and 14 and of coupling region 16 are mutually adjacent.

On the other side of left waveguide 12 from coupling region 16 is a left bounding region 30 that has a proximal end 34 adjacent to proximal end 18 of left waveguide 12 and a distal end 40 adjacent to distal end 24 of left waveguide 12. A switching section 32 of left bounding region 30 extends from a switching section proximal side 36 to a switching section distal side 38. Within switching section 32, left bounding region 30 has an effective index of refraction \overline{n}₄. Proximal to switching section 32, left bounding region 30 has an effective index of refraction that decreases adiabatically from a value of \overline{n}₀₁ at proximal end 34 to a value of \overline{n}₄ at proximal side 36. Distal to switching section 32, left bounding region 30 has an effective index of refraction that increases adiabatically from a value of \overline{n}₄ at distal side 38 to a value of \overline{n}₀₁ at distal end 40. \overline{n}₁, \overline{n}₃, \overline{n}₄ and \overline{n}₀₁ are related by \overline{n}₄<\overline{n}₃<\overline{n}₀₁<\overline{n}₁.

Similarly, on the other side of right waveguide 14 from coupling region 16 is a right bounding region 50 that has a proximal end 54 adjacent to proximal end 20 of right waveguide 14 and a distal end 60 adjacent to distal end 26 of right waveguide 14. A switching section 52 of right bounding region 50 extends from a switching section proximal side 56 to a switching section distal side 58. Within switching section 52, right bounding region 50 has an effective index of refraction \overline{n}₅. Proximal to switching section 52, right bounding region 50 has an effective index of refraction that decreases adiabatically from a value of \overline{n}₀₂ at proximal end 54 to a value of \overline{n}₅ at proximal side 56. Distal to switching section 52, right bounding region 50 has an effective index of refraction that increases adiabatically from a value of \overline{n}₅ at distal side 58 to a value of \overline{n}₂ at distal end 60. \overline{n}₂, \overline{n}₃, \overline{n}₅ and \overline{n}₀₂ are related by \overline{n}₅<\overline{n}₃<\overline{n}₀₂<\overline{n}₂.

Waveguide 12 is shown optically coupled, at proximal end 18, to an input optical fiber 70. Similarly, waveguide 12 is shown optically coupled, at distal end 24, to an output optical fiber 72, and waveguide 14 is shown optically coupled, at distal end 26, to an output optical fiber 74.

Also shown in FIG. 1 are the x and z axes of a coordinate system that is defined below in FIG. 2.

A physical embodiment of waveguide structure 10 is described below.

Preferably, \overline{n}₄=\overline{n}₅.

As noted above, optical modes confined to waveguides 12 and 14 are coupled via one or optical modes that span waveguides 12 and 14 and coupling region 16, by periodic perturbations of the effective indices of refraction. One way of achieving these perturbations is to configure waveguides 12 and 14 to meander transversely, either in the plane of waveguides 12 and 14 or perpendicular to that plane. A second way of achieving these perturbations is to configure waveguides 12 and 14 with thicknesses that vary periodically in the z direction, again either in the plane of waveguides 12 and 14 or perpendicular to that plane. A third way of achieving these perturbations is by providing a mechanism for reversibly perturbing the effective indices of refraction This reversible perturbation may be uniform in the z direction when applied in combination with the first or the second perturbation. Alternatively, this reversible perturbation may be periodic in the z direction, either alone or in combination with the first or the second perturbation. The mechanism may be thermo-optic, piezo-electric, acousto-optic or electro-optic. Alternatively, the mechanism may rely on the reversible injection of charge carriers into the relevant portions of waveguide structure 10.

The perturbations of the present invention are defined to be not so large as to change the inequality relationships of the effective indices of refraction.

One application of waveguide structure 10 is as part of a directional coupler, which in turn is a component of a power divider, a wavelength filter, an optical modulator or an attenuator.

Another application of waveguide structure 10 is as part of an optical switch. Multiple such optical switches constitute an optical switch matrix. An important feature of such an optical switch matrix, for switching optical signals from a first number of input optical waveguides such as input optical fiber 70 to a second number of output optical waveguides such as output optical fibers 72 and 74, is that the waveguides of the switch all are substantially straight and parallel. Such an optical switch matrix includes several instances of waveguide structure 10, such that each adjacent pair of switching waveguides, such as waveguides 12 and 14, is coupled as described above.

The directional coupler of the second aspect of the present invention is similar to waveguide structure 10, insofar as this directional coupler includes two parallel waveguides, such as waveguides 12 and 14, on either side of a coupling region such as coupling region 16, with the respective effective refractive indices of both waveguides being greater than the effective refractive index of the coupling region. However, the physical embodiment of this directional coupler need not be a planar waveguide structure, but may be based, for example, on optical fibers as the waveguides. This directional coupler also includes mechanisms for reversibly inducing quasiperiodic perturbations in the refractive indices of the waveguides. These quasiperiodic perturbations have envelope functions that vary monotonically in opposite senses along the waveguides. The mechanisms may be thermo-optic, piezo-electric, acousto-optic or electro-optic. Alternatively, the mechanisms may rely on the reversible injection of charge carriers into the waveguides.

Preferably, the waveguides of the directional coupler of the second aspect of the present invention are single-mode waveguides.

Applications of the directional coupler of the second aspect of the present invention include using this directional coupler as a component of a power divider, a wavelength filter, an optical switch, an optical modulator or an attenuator.

The scope of the present invention includes using the directional coupler of the second aspect of the present invention to divert at least a portion of electromagnetic energy, propagating in one of the waveguides, to the other waveguide. Preferably, the envelope function of the waveguide, in which the electromagnetic energy initially propagates, increases monotonically in the direction of propagation, and the envelope function of the waveguide, into which the electromagnetic energy is diverted, decreases monotonically in the propagation direction.

### BRIEF DESCRIPTION OF THE DRAWINGS

The invention is herein described, by way of example only, with reference to the accompanying drawings, wherein:

FIG. 1 illustrates the effective refractive index structure of a planar waveguide structure of the first aspect of the present invention;

FIG. 2 illustrates the physical structure of the planar waveguide structure of FIG. 1;

FIG. 3 is a cross section of the fourth layer of the planar waveguide structure of FIG. 2, parallel to the xz plane;

FIGS. 4A and 4B are schematic representations of the effective indices of refraction of the planar waveguide structure of FIGS. 1 and 2, proximal and distal to the switching sections (FIG. 4A) vs. within and between the switching sections (FIG. 4B);

FIG. 5 is FIG. 3 including periodic static perturbations, parallel to the xz plane, of the waveguide regions, and also including mechanisms for inducing uniform dynamic perturbations of the effective indices of refraction;

FIG. 6 illustrates a periodic static perturbation, parallel to the yz plane, of one of the waveguide regions of FIG. 2;

FIG. 7 is FIG. 3 with mechanisms for inducing periodic dynamic perturbations of the effective indices of refraction;

FIG. 8 is FIG. 7 without the static perturbations;

FIG. 9 is FIG. 5 with alternative periodic static perturbations, in the xz plane, of the waveguide regions;

FIG. 10 is FIG. 6 with an alternative periodic static perturbation, in the yz plane, of the waveguide region;

FIG. 11 is a schematic illustration of a 4×4 non-blocking optical switch matrix of the first aspect of the present invention;

FIG. 12 is a schematic longitudinal cross section of a directional coupler of the second aspect of the present invention.

### DESCRIPTION OF TEE PREFERRED EMBODIMENTS

A first aspect of the present invention is a waveguide structure for implementing the intermediate-state-assisted optical coupler of Vorobeichik et al. A second aspect of the present invention is yet another directional coupler that couples optical modes that propagate separately in taco parallel waveguides via a third optical mode common to the two waveguides. The present invention can be used in optical devices such as power dividers, wavelength filters, optical modulators, attenuators and optical switch matrices.

The principles and operation of optical couplers according to the present invention may be better understood with reference to the drawings and the accompanying description.

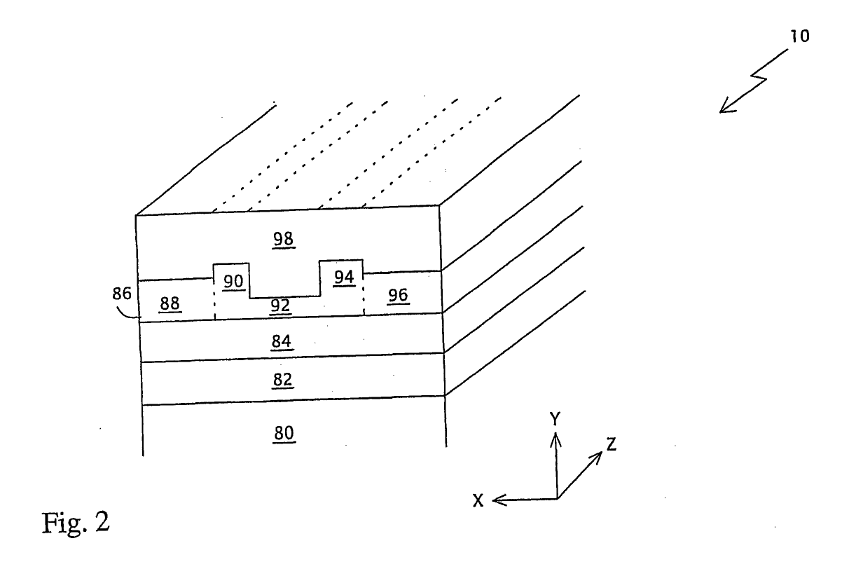

Referring again to the drawings, FIG. 2 illustrates the physical structure of planar waveguide structure 10. A substrate layer 80 has an index of refraction n₁. A second layer 82 has an index of refraction n₂ which may be smaller than, larger than or equal to n₁. A third layer 84 has an index of refraction n₃ which may be smaller than, larger than or equal to n₂. A fourth layer 86 includes five regions 88, 90, 92, 94 and 96. Region 92 has an index of refraction n₄ that is larger than n₃. Regions 90 and 94 have respective indices of refraction n_{5 and n}₅′ which may be smaller than, larger than or equal to n₄, but which must be larger than n₃. n_{5 and n}₅′ may be equal (symmetric configuration) or unequal (asymmetric configuration). A fifth layer 98 has an index of refraction n₆ that is smaller than n₄, n₅ and n₅′. The indices of refraction of regions 88 and 96 vary spatially, as described below.

Also shown in FIG. 2 is the (x,y,z) coordinate system that is used to describe planar wavelength structure 10. The various layers are parallel to the xz plane. Light propagates in the +z direction, from the proximal end of planar waveguide structure 10, which is the end of planar waveguide structure 10 that is shown in FIG. 2, to the distal end of planar waveguide structure 10.

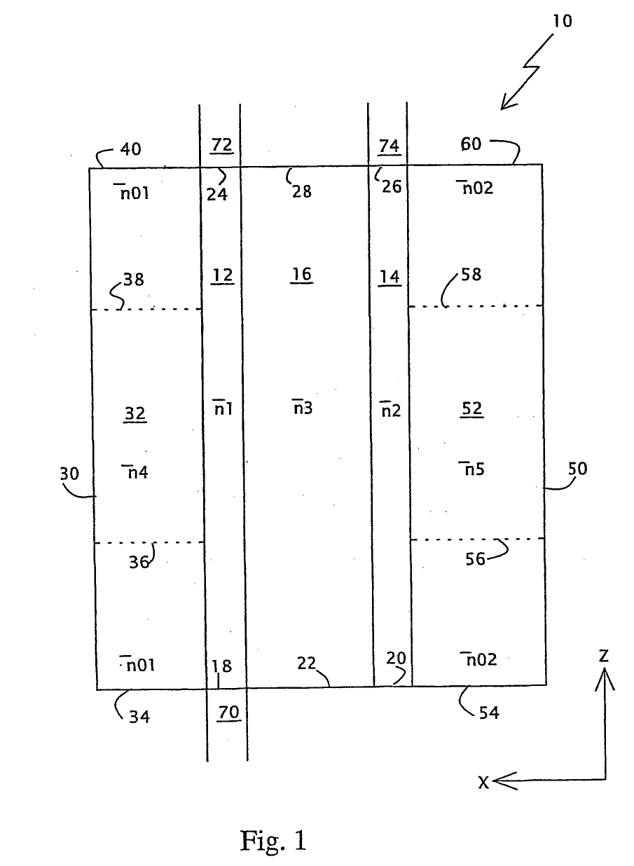

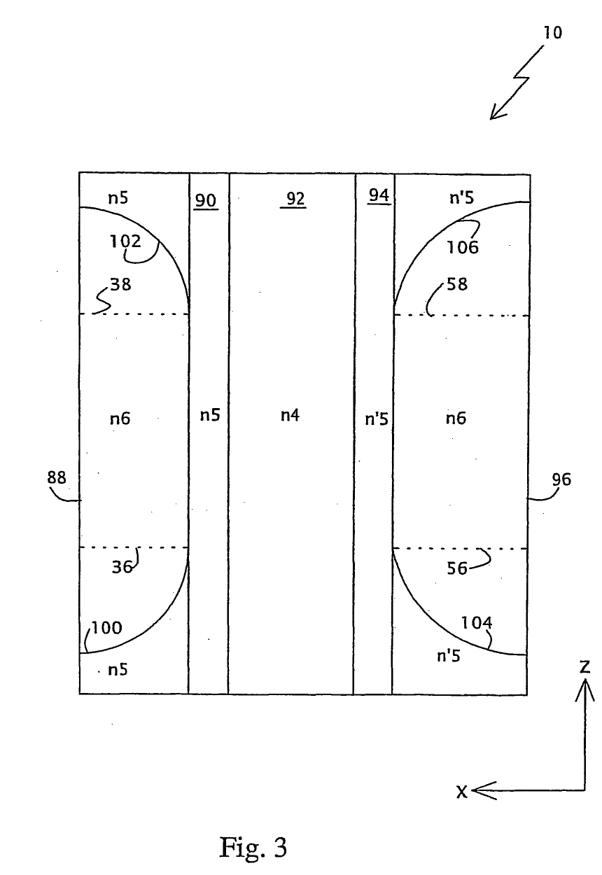

FIG. 3 is a cross section of layer 86 parallel to the xz plane, showing the refractive index structure of layer 86. As noted above, regions 90 and 94 have refractive index n₅ and region 92 has refractive index n₄. Dashed lines 36, 38, 56 and 58 correspond to proximal side 36, distal side 38, proximal side 56 and distal side 58 of FIG. 1, respectively. Between dashed lines 36 and 38, the index of refraction of region 88 is n₆. The portion of region 88 in which the index of refraction is n₆ extends past dashed lines 36 and 38, to interfaces 100 and 102. Proximal of interface 100 and distal of interface 102, the index of refraction of region 88 is n₅. Similarly, between dashed lines 56 and 58, the index of refraction of region 96 is n₆. The portion of region 96 in which the index of refraction is n₆ extends past dashed lines 56 and 58, to interfaces 104 and 106. Proximal of interface 104 and distal of interface 106, the index of refraction of region 96 is n₅′.

The following table lists the thicknesses of the regions of layer 86:

| Region | Thickness |
|---|---|
| 88 | D₁ |
| 90 | A |
| 92 | C |
| 94 | B |
| 96 | D₂ |

These thicknesses are related as follows: A and B may be equal or different, C<D₁<A, and C<D₂<B.

With input waveguide 70 optically coupled to region 90 at the proximal side of region 90, with output waveguide 72 optically coupled to region 90 at the distal side of region 90, and with output waveguide 74 optically coupled to region 94 at the distal side of region 94, this index-of-refraction and thickness structure gives planar waveguide structure 10 the effective indices of refraction, with respect to light introduced to planar waveguide structure 10 via input waveguide 70, that are illustrated in FIG. 1. Interface 100 is positioned so that the effective index of refraction of left bounding region 30 decreases adiabatically from \overline{n}₀₁, at proximal end 34 to \overline{n}₄ at proximal side 36. Interface 102 is positioned so that the effective index of refraction of left bounding region 30 increases adiabatically from \overline{n}₄ at distal side 38 to \overline{n}₀₁, at distal end 40. Interface 104 is positioned so that the effective index of refraction of right bounding region 50 decreases adiabatically from \overline{n}₀₂ at proximal end 54 to \overline{n}₅ at proximal side 56. Interface 106 is positioned so that the effective index of refraction of right bounding region 50 increases adiabatically from \overline{n}₅ at distal side 58 to \overline{n}₀₂ at distal end 60.

One class of materials from which planar waveguide structure 10 may be fabricated is silica with germanium doping (SiO₂/Ge). Silica has an index of refraction, with respect to light having a free space wavelength of 1550 nm, of 1.44. Doping with germanium can increase this index of refraction by as much as 1.5%. Another class of materials from which planar waveguide structure 10 may be fabricated is silica with nitrogen doping (SiON). Doping silica with nitrogen can increase the index of refraction, with respect to light having a free space wavelength of 1550 nm, to as much as 1.6.

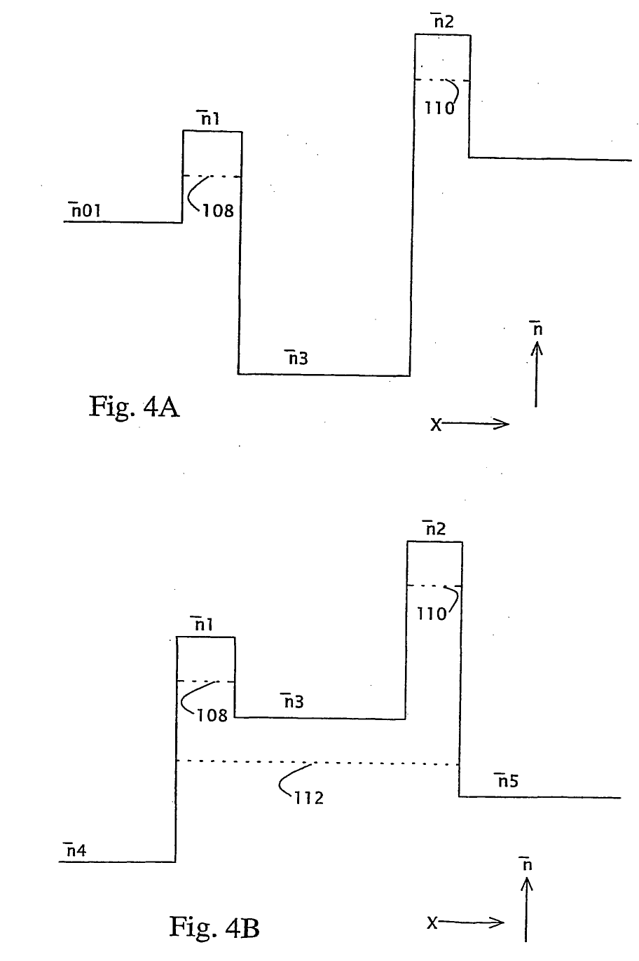

FIG. 4A is a schematic representation of the effective index of refraction \overline{n}, as a function of x, proximal and distal to switching sections 32 and 52. FIG. 4B is a similar schematic representation of the effective index of refraction \overline{n}, as a function of x, within and between switching sections 32 and 52. Note that FIGS. 4A and 4B illustrate the asymmetric configuration (n₅≠n₅′). Proximal and distal to switching sections 52, planar waveguide structure 10 supports only optical modes, represented symbolically by dashed lines 108 and 110, that are localized to waveguides 12 and 14. Between switching sections 32 and 52, planar waveguide structure 10 also supports optical modes, represented symbolically by a dashed line 112, that span both waveguides 12 and 14 and also coupling region 16. The presence of common optical modes 112 enables efficient directional coupling between waveguides 12 and 14 using selective optical mode coupling between (typically zero-order) optical modes 108 and 110 and at least one of high order common optical modes 112. This coupling is achieved by any method of transferring the optical power carried by optical mode 108 to optical mode 110 and/or vice versa, for example, periodic or almost periodic perturbation of the refractive indices of planar waveguide structure 10, and periodic or almost periodic changes in the geometry of regions 90 and 94.

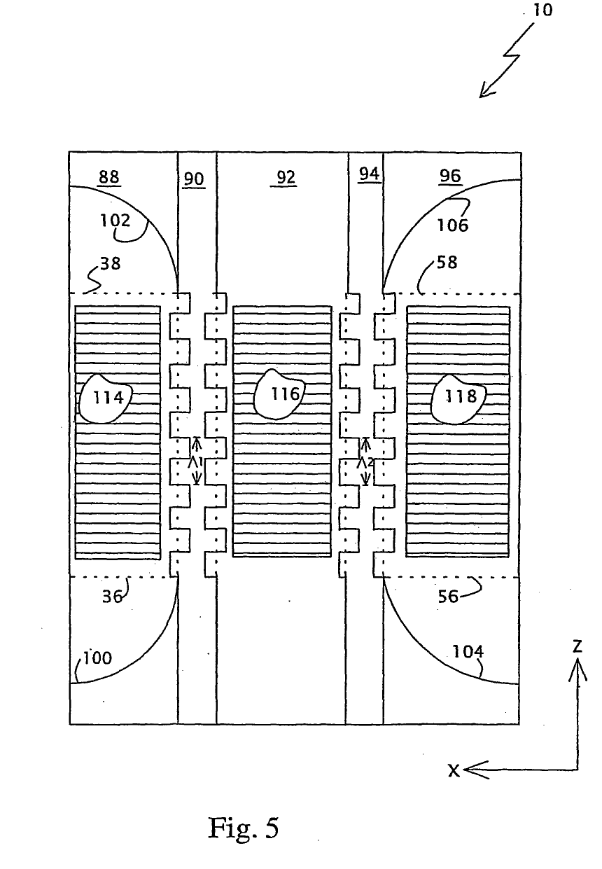

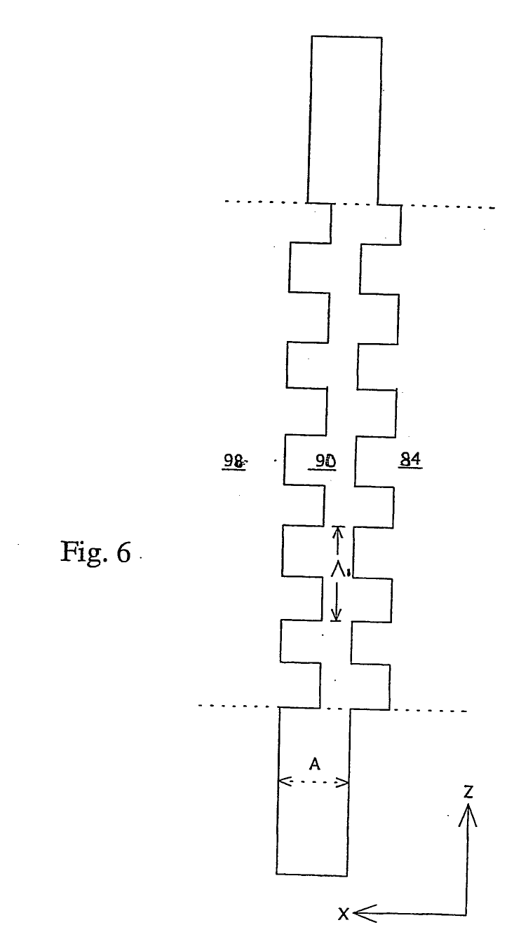

One such geometric perturbation is illustrated in FIG. 5, which is a cross section of planar waveguide structure 10 parallel to the xz plane, similar to the cross section of FIG. 3, but showing regions 90 and 94 meandering periodically, parallel to the xz plane. Another such geometric perturbation is illustrated in FIG. 6, which is a partial cross section of planar waveguide structure 10, parallel to the yz plane, through a variant of region 90 that meanders periodically, parallel to the yz plane.

To achieve efficient and selective optical mode coupling, the periods of the meanders should correspond to the propagation constants of the optical modes:

$$\begin{matrix}{β}_{1} - {β}_{3} \approx \frac{2 π}{{Λ}_{1}} & ( 1 ) \\ {β}_{2} - {β}_{3} \approx \frac{2 π}{{Λ}_{2}} & ( 2 )\end{matrix}$$

where β₁ and β₂ are the propagation constants of the zero-order optical modes of waveguides 12 and 14, respectively; where β₃ is the propagation constant of the third, common optical mode; where Λ₁ is the meander wavelength of region 90; and where Λ₂ is the meander wavelength of region 94 (see FIGS. 5 and 6). If equations (1) and (2) are satisfied, then the optical power initially located in the zero-order optical mode of waveguide 12 is transferred to the common high-order optical mode by the periodic perturbation due to the meanders of region 90, and is simultaneously transferred from the common optical mode to the zero-order optical mode of waveguide 14 by the periodic perturbation due to the meanders of region 94. In this manner, a complete directional coupling is achieved despite the fact that the direct coupling between the two zero-order optical modes is negligible.

A directional coupler built in this maimer also can be used as an optical switch. Two regimes of switching operation are possible.

In a normally “on” switch, the meander parameters are chosen so that the optical mode coupling is efficient and a complete power transfer between waveguides 12 and 14 is achieved A dynamic perturbation of refractive indices is used to alter the propagation constants of the optical modes and to deactivate the optical mode coupling. In this regime, the optical switch normally is “on”. The change of the propagation constants of the optical modes can be achieved in a variety of ways, such as via the thermo-optic, piezo-electric or acousto-optic or electro-optic effects. In FIG. 5, shaded portions 114, 116 and 118 represent mechanisms for the application of such perturbations to switching section 32, coupling region 16 and switching section 52, respectively, to modify effective indices of refraction \overline{n}₄, \overline{n}₃ and \overline{n}₅, respectively. For example, perturbative mechanisms 114, 116 and 118 may be resistive heating elements on the top or bottom surfaces of planar waveguide structure is 10. The spatial extent of the perturbations induced by mechanisms 114, 116 and 118 extend beyond their respective regions 30, 16 and 50: mechanism 114 also perturbs effective index of refraction n; mechanism 116 also perturbs effective indices of refraction \overline{n}₁ and \overline{n}₂; and mechanism 118 also perturbs effective index of refraction \overline{n}₂. Each of the three resistive heating elements can be heated to different (or equal) temperatures to induce the desired changes in the refractive indices in the regions therebelow (or thereabove). The change of the refractive indices in turn modifies the optical properties (i.e., the propagation constants) of the zero-order optical modes of waveguides 12 and 14 as well as the high-order common optical modes, thus activating the switch. It should be noted that the perturbations should not be so large as to change the inequality relationships among the effective indices of refraction.

Alternatively, perturbative mechanisms 114, 116 and 113 could be electrodes for reversible injection of charge carriers to switching section 32, coupling region 16 and switching section 52, respectively.

In a normally “off” switch, the meander parameters are chosen so that the optical mode coupling is inefficient, i.e., equations (1) and (2) are not satisfied. The dynamic change of refractive indices is used to alter the propagation constants of the optical modes and to activate the optical mode coupling. In this regime, the optical switch normally is “off”, and the dynamic perturbation activates the switch.

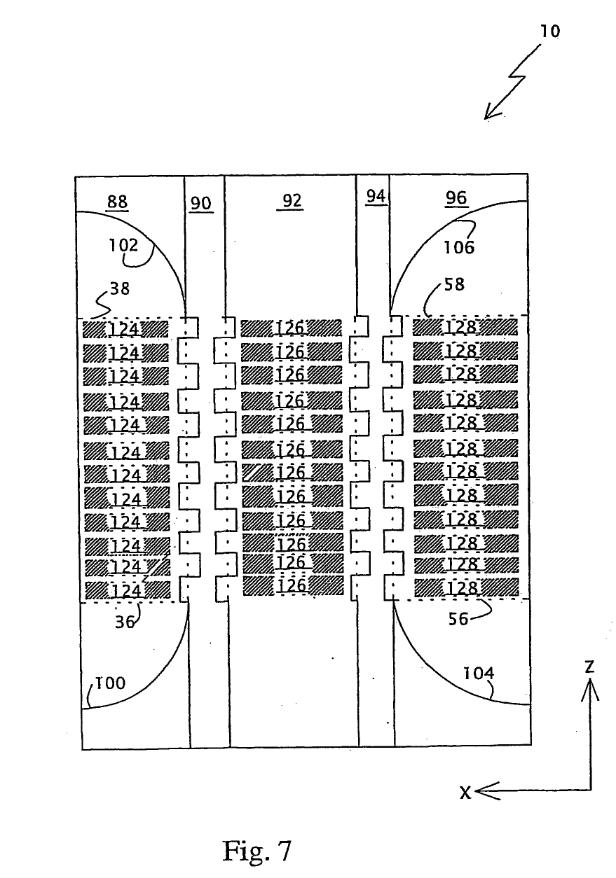

FIG. 5 illustrates the combination of a z-dependent (specifically, periodic) static perturbation of indices of refraction with a z-independent dynamic perturbation of indices of refraction. FIG. 7 illustrates z-dependent static and dynamic perturbations of indices of refraction. Specifically, FIG. 7 is a cross section of planar waveguide structure 10 parallel to the xz plane, similar to the cross section of FIG. 5, but with segmented perturbative mechanisms 124, 126 and 128 that apply dynamic perturbations that vary periodically (or almost periodically) in the z direction. The average change of the refractive indices induced by the perturbation is used to tune (in a normally “off” switch) or detune (in a normally “on” switch) the propagation constants of the optical modes with respect to the parameters of the static perturbations. The difference between the refractive index changes induced in adjacent segments 124, in adjacent segments 126 or in adjacent segments 128 is used to adjust the strength of the refractive index perturbation that couples the optical modes. This ability to vary the total optical mode coupling strength allows maximization of the power transfer efficiency obtained using the two (static and dynamic) optical mode couplings.

For example, perturbative segments 124, 126 and 128 could be resistive heating elements placed above or below their respective regions of planar waveguide structure 10, in three arrays as shown, for the purpose of inducing thermo-optic perturbations of the indices of refraction. In each of the three arrays, the resistive heating elements can be heated to different (or equal) temperatures to induce changes in the refractive indices of the regions of planar waveguide structure 10 therebelow or thereabove. The average change of the refractive indices modifies the optical properties (i.e., the propagation constants) of the zero-order optical modes of waveguides 12 and 14 as well as the high-order common optical modes, thus activating (in the normally “off” switch) or deactivating (in the normally “on” switch) the static perturbations. The alternate heating of adjacent resistive heating elements in each array produces a periodic (or almost periodic) perturbation of the refractive indices which couples (along with the static perturbation) the zero-order optical modes of waveguides 12 and 14 with the high-order optical mode common to both waveguides 12 and 14.

Alternatively, perturbative segments 124, 126 and 128 could be electrodes for reversible injection of charge carriers into their respective regions of planar waveguide structure 10.

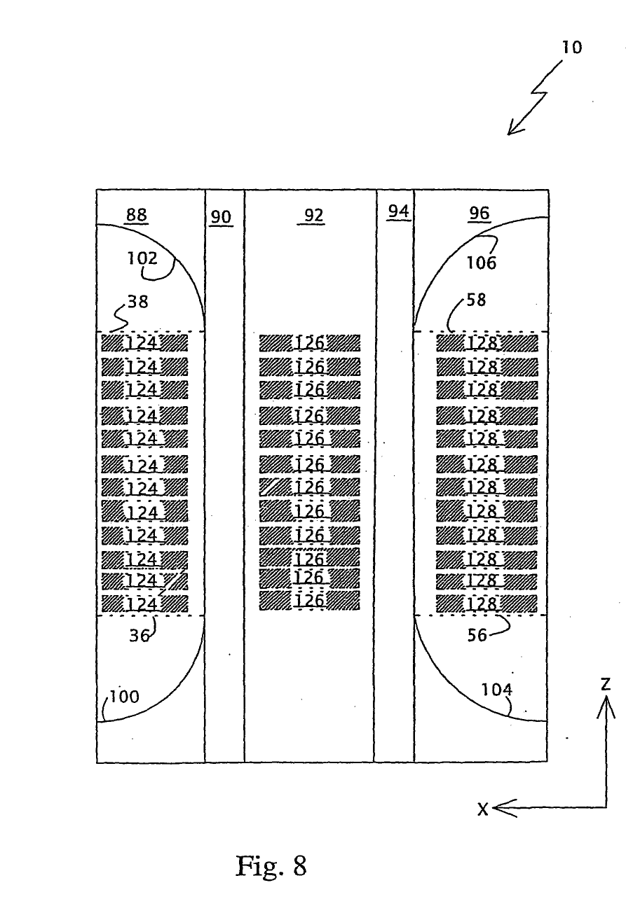

FIG. 8 illustrates z-dependent dynamic perturbation in the absence of a static perturbation. Specifically, FIG. 8 is a cross section of planar waveguide structure parallel to the xz plane, similar to the cross section of FIG. 3, insofar as regions 90 and 94 are straight rather than meandering, but with segmented perturbative mechanisms 124, 126 and 128 that apply dynamic perturbations that vary periodically (or almost periodically) in the z direction, as in FIG. 7. In this case, directional coupling is achieved by applying two dynamic perturbations of the refractive indices. These perturbations selectively couple the zero-order optical modes of each of waveguides 12 and 14 to the high-order optical mode common to both waveguides 12 and 14. Thus, the optical power initially carried by the zero-order optical mode of waveguide 12 is transferred to the zero-order optical mode of waveguide 14 via the third, common high-order optical mode.

In the case illustrated in FIG. 8, the perturbation of the indices of refraction is induced dynamically and there is no static perturbation. Thus, in the absence of any perturbation, waveguides 12 and 14 are sufficiently far apart that the directional coupling between the zero-order optical modes of waveguides 12 and 14 is negligible. When the dynamic perturbation is induced, the optical mode coupling is activated and directional coupling is achieved. Therefore, this configuration can be used as a normally “off” switch. The dynamic perturbation can be achieved in the same way as before, for example, thermo-optically, piezo-electrically or acousto-optically.

For example, perturbative segments 124, 126 and 128 could be resistive heating elements placed above or below their respective regions of planar waveguide structure 10, in three arrays as shown, for the purpose of inducing thermo-optic perturbations of the indices of refraction. In this case, resistive heating elements 124 are used to couple the zero-order optical mode of waveguide 12 to the higher-order common optical mode, resistive heating elements 128 are used to couple the zero-order optical mode of waveguide 14 to the higher-order common optical mode, and resistive heating elements 126 are used to couple both zero-order optical modes to the higher-order common optical mode simultaneously. Array 124, array 126 and array 123 can produce either periodically alternating or constant (z-independent) heating. The alternating heating is used to induce optical mode coupling, and the constant heating is used to change the refractive indices. The z-independent change of the indices of refraction produces a corresponding change of the propagation constants of the optical modes, with the differences between these propagation constants being adjusted in accordance with the wavelengths of the periodic perturbations, in accordance with equations (1) and (2).

Alternatively, perturbative segments 124, 126 and 128 could be electrodes for reversible injection of charge carriers into their respective regions of planar waveguide structure 10.

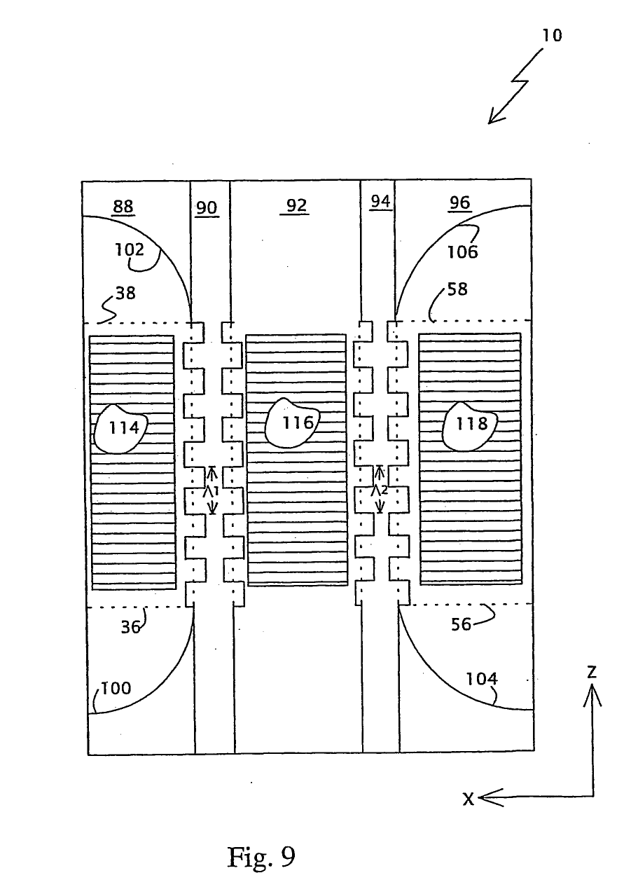

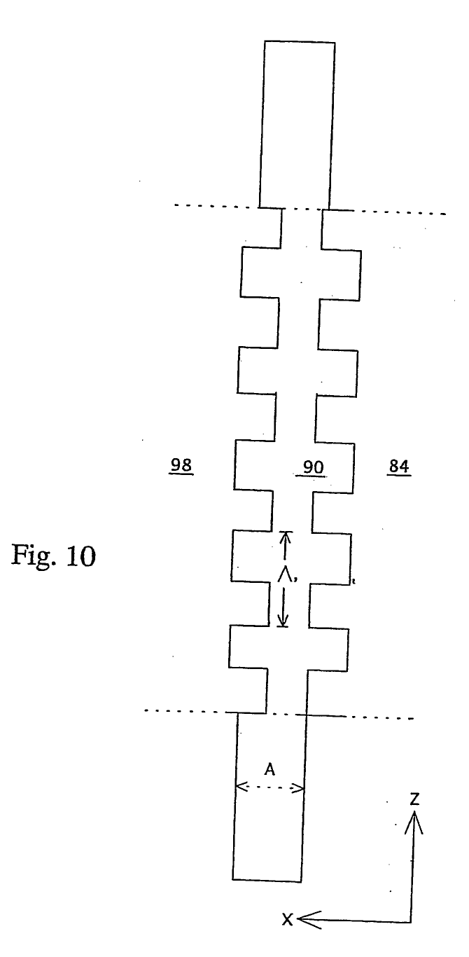

FIG. 9 is a variant of FIG. 5 that shows an alternative periodic geometric perturbation of regions 90 and 94: periodic variations of the thicknesses of regions 90 and 94 parallel to the xz plane. FIG. 10 is a variant of FIG. 6 that shows another alternative periodic geometric perturbation of region 90: periodic variations of the thickness of region 90 parallel to the yz plane.

In all configurations of the 2×2 optical switch described above, the optical waveguides are straight and parallel to each other. There is no need to change the separation distance between the optical waveguides along the propagation direction, because the separation distance is kept constant and large to preclude direct coupling between the zero-order optical modes of the waveguides. Directional coupling is achieved via mode coupling between the zero-order optical modes of the waveguides and the common high-order optical modes. In fact, this optical mode coupling is almost totally insensitive to the distance between the waveguides: optical switching is possible between waveguides which are many zero-order optical mode diameters apart. Because the waveguides are straight and parallel, larger switching matrices based on the 2×2 switch of the present invention are particularly compact and efficient.

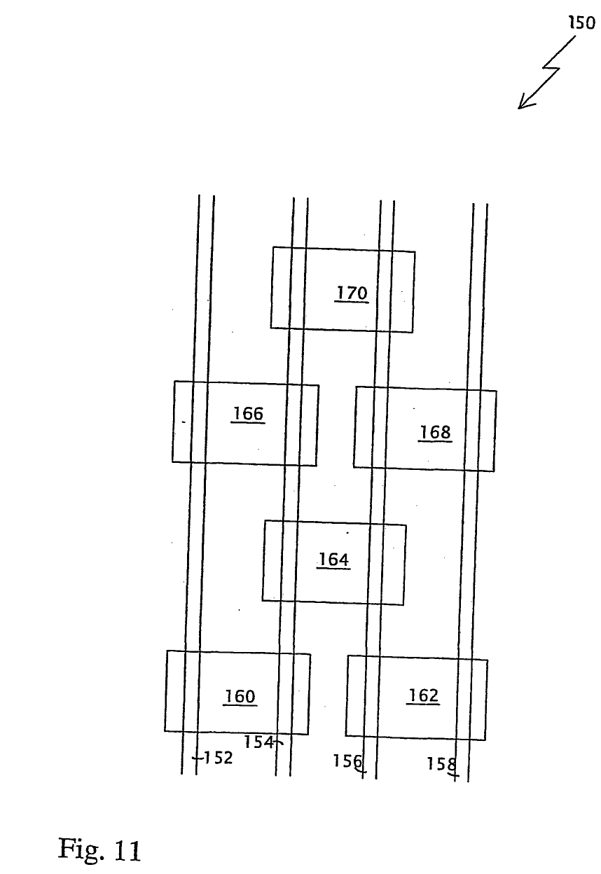

FIG. 11 is a schematic illustration of a 4×4 non-blocking optical switch matrix 150 that is based on six 2×2 optical switches 160, 162, 164, 166, 168 and 170 of the present invention that couple four straight, parallel waveguides 152, 154, 156 and 158 as shown. Each 2×2 optical switch of FIG. 11 is essentially identical to planar waveguide structure 10 of FIG. 1, and couples two adjacent waveguides: waveguides 152 and 154, waveguides 154 and 156, or waveguides 156 and 158. For example, the portion of waveguide 152 internal to switch 160 is waveguide 12 of switch 160, and is optically coupled by switch 160 to the portion of waveguide 154 internal to switch 160, which is waveguide 14 of switch 160; the portion of waveguide 152 internal to switch 166 is waveguide 12 of switch 166, and is optically coupled by switch 166 to the portion of waveguide 154 internal to switch 166, which is wave guide 14 of switch 166; and the portion of waveguide 154 internal to switch 164 is waveguide 12 of switch 164, and is optically coupled by switch 164 to the portion of waveguide 156 internal to switch 164, which is waveguide 14 of switch 164, etc. There is no need to connect the 2×2 switches of FIG. 11 by S-bends. Therefore, the total length of 4×4 switch matrix 150 is significantly smaller than the length of comparable prior art switch matrices that require long S-bends. Moreover, because the waveguides are kept parallel in each separate 2×2 switch, there is no need to introduce S-bends or other slow variations of the inter-waveguide distances within the 2×2 switches. Each 2×2 switch can be as short as about one millimeter. Thus, large switching matrices can be produced on a scale that is much smaller than in the cases where S-bends or other slow variations of inter-waveguide distances are needed. Similarly, larger non-blocking switching matrices can be designed. Existing architectures can be used as well as novel architectures which are suitable for connecting large numbers of switches built around straight, parallel waveguides.

For switching purposes, each of switches 160, 162, 164, 166, 168 and 170 is placed in one of two states: a straight-through state, in which no power is exchanged between the respective waveguides, and a crossover state, in which power is exchanged totally between the two respective waveguides. The following table shows the states that switches 160, 162, 164, 166, 168 and 170 are set to in order to achieve the twenty-four possible switching combinations, for a signal “a” that enters switch matrix 150 via waveguide 152, a signal “b” that enters switch matrix 150 via waveguide 154, a signal “c” that enters switch matrix 150 via waveguide 156 and a signal “d” that enters switch matrix 150 via waveguide 158. The first four columns show which signal exits switch matrix 150 via each of waveguides 152, 154, 156 and 158. The last six columns show the corresponding settings of switches 160, 162, 164, 166, 168 and 170. A straight-through state is represented by “=”. A crossover state is represented by “X”.

| OUTPUT | | | | SWITCH SETTINGS | | | | | |
|---|---|---|---|---|---|---|---|---|---|
| 152 | 154 | 156 | 158 | 160 | 162 | 164 | 166 | 168 | 170 |
| a | b | c | d | = | = | = | = | = | = |
| a | b | d | c | = | = | = | = | X | = |
| a | c | b | d | = | = | = | = | = | X |
| a | c | d | b | = | = | X | = | X | = |
| a | d | b | c | = | = | = | = | X | X |
| a | d | c | b | = | = | X | = | X | X |
| b | a | c | d | = | = | = | X | = | = |
| b | a | d | c | = | = | = | X | X | = |
| b | c | a | d | = | = | = | X | = | X |
| b | c | d | a | X | = | X | = | X | = |
| b | d | a | c | = | = | = | X | X | X |
| b | d | c | a | X | = | X | = | X | X |
| c | a | b | d | = | = | X | X | = | = |
| c | a | d | b | = | = | X | X | X | = |
| c | b | a | d | = | = | X | X | = | X |
| c | b | d | a | X | = | X | X | X | = |
| c | d | a | b | = | = | X | X | X | X |
| c | d | b | a | X | = | X | X | X | X |
| d | a | b | c | = | X | X | X | = | = |
| d | a | c | b | = | X | X | X | X | = |
| d | b | a | c | = | X | X | X | = | X |
| d | b | c | a | X | X | X | X | X | = |
| d | c | a | b | = | X | X | X | X | X |
| d | c | b | a | X | X | X | X | X | X |

The directional coupler of the second aspect of the present invention is based on non-evanescent adiabatic optical mode coupling. A special form of refraction index perturbation is used, such that optical mode coupling is achieved by varying the coupling strength along the propagation direction. Similar principles were used by E. Peral and A. Yariv, as described in “Supermodes of grating-coupled multi-mode waveguides and applications to mode conversion between copropagating modes mediated by backward Bragg scattering”. J. Lightwave Tech., vol. 17 pp. 942-947 (1999), for mode conversion between optical modes of a multi-mode waveguide. Specifically, mode conversion between co-propagating optical modes within the same waveguide was mediated by a backward-propagating optical mode. By contrast, in the directional coupler of the second aspect of the present invention, optical power is transferred from one waveguide to another; and the waveguides may be, and indeed usually are, single-mode waveguides.

To understand adiabatic optical power transfer between two waveguides, consider a system in which the optical field E is assumed to be given by a linear combination of three optical modes, such that

$$E ( x , y , z ) = {C}_{1} ( z ) exp ( ⅈ {β}_{1} z ) {Φ}_{1}^{( 0 )} ( x , y ) + {C}_{2} ( z ) exp ( ⅈ {β}_{2} z ) {Φ}_{2}^{( 0 )} ( x , y ) + {C}_{3} ( z ) exp ( ⅈ {β}_{3} z ) {Φ}_{3}^{( 0 )} ( x , y ) \qquad ( 3 )$$

where Cⱼ(z) are the z-dependent coefficients of the ideal optical modes Φⱼ⁽⁰⁾(x,y) and z is the direction of propagation. These ideal optical modes and their propagation constants βⱼ describe an optical wave propagating in a medium with a z-independent refractive index n(x,y).

In the directional coupling problem, Φ₁⁽⁰⁾(x,y) and Φ₂⁽⁰⁾(x,y) represent optical fields localized in the first and second waveguides, respectively. The waveguides are sufficiently far apart that direct evanescent coupling between Φ₁⁽⁰⁾(x,y) and Φ₂⁽⁰⁾(x,y) is negligible.

Directional coupling and optical switching via adiabatic optical mode coupling can be achieved for either equivalent waveguides or for differing waveguides. The difference between the waveguides may be in their refractive indices, in their geometries, or in both. If the two waveguides are different (asynchronous directional coupler), Φ₁⁽⁰⁾(x,y) is approximately the zero-order optical mode of the first waveguide and Φ₂⁽⁰⁾(x,y) is approximately the zero-order optical mode of the second waveguide. If the two waveguides are equivalent (synchronous directional coupler), then the optical modes of the entire structure can be classified into optical modes of even and odd parity. Because the waveguides are far apart, the odd and even optical modes are almost degenerate. In this case Φ₁⁽⁰⁾(x,y) is the sum of the first even optical mode and the first odd optical mode, and is localized in one of the waveguides; and Φ₂⁽⁰⁾(x,y) is the difference between the first even optical mode and the first odd optical mode, and is localized in the other waveguide. Φ₃⁽⁰⁾(x,y) is a high-order optical mode of the entire two-waveguide structure, and is different from the high-order optical modes of the waveguides considered individually.

The three optical modes Φⱼ⁽⁰⁾(x,y), j=1,2,3, are coupled by modulating the refractive index in the direction of propagation:

$$V ( x , y , z ) = \frac{{ω}^{2}}{{c}^{2}} [ {n}^{2} ( x , y , z ) - {\hat{n}}^{2} ( x , y ) ] \qquad ( 4 )$$

In equation (4), the modulation of the refractive index is expressed in terms of V, the product of the (coordinate-dependent) perturbation of the electric permeability (the square of the index of refraction) and the square of the free space wavenumber (ω/c). \hat{n}(x,y) is the refractive index distribution of the unperturbed waveguide. ω is the angular frequency of the (monochromatic) optical wave, and c is the speed of light in a vacuum. The refractive index perturbation is assumed to be of the form

$$\begin{matrix}\begin{matrix}V ( x , y , z ) = \frac{{ω}^{2}}{{c}^{2}} [ Δ {ϵ}_{1} ( x , y ) {g}_{1} ( z ) cos ( \frac{2 π}{{Λ}_{1}} ) z + \\ Δ {ϵ}_{2} ( x , y ) {g}_{2} ( z ) cos ( \frac{2 π}{{Λ}_{2}} ) z ] such that \end{matrix} & ( 5 ) \\ \frac{2 π}{{Λ}_{1}} \approx {β}_{1} - {β}_{3} & ( 6 ) \\ \frac{2 π}{{Λ}_{12}} \approx {β}_{2} - {β}_{3} & ( 7 )\end{matrix}$$

where the βⱼ are the propagation constants of the optical modes. Δε₁(x,y) and Δε₂(x,y) represent local amplitudes of the perturbation of the refractive index that couples Φ₃⁽⁰⁾(x,y) with Φ₁⁽⁰⁾(x,y) and Φ₂⁽⁰⁾(x,y). g₁(z) and g₂(z) are z-dependent envelope functions that represent the change in optical mode coupling strength in the propagation direction.

Optical mode coupling is achieved by periodic or quasi-periodic perturbation of the refractive index. In the limiting case of infinitely long period, g₁(z)=g₂(z)=1.

It is assumed that the refractive index modulation is such that Φ₁⁽⁰⁾(x,y) and Φ₂⁽⁰⁾(x,y) are not directly coupled. In addition, the perturbation of the refractive index with wavelength Λ₁ couples only Φ₁⁽⁰⁾(x,y) and Φ₃⁽⁰⁾(x,y), whereas the perturbation of the refractive index with wavelength Λ₂ couples only Φ₂⁽⁰⁾(x,y) and Φ₃⁽⁰⁾(x,y). It can be shown in such a case that the z-dependent coefficients of the optical modes (equation (3)) satisfy the following equation:

$$2 i {k}_{0} \frac{ⅆ}{ⅆ z} ( \begin{matrix}{C}_{1} \\ {C}_{2} \\ {C}_{{3}^{-}}\end{matrix} ) = ( \begin{matrix}0 & 0 & {κ}_{1} \\ 0 & 0 & {κ}_{2} \\ {κ}_{1} & {κ}_{2} & 0 -\end{matrix} ) ( \begin{matrix}{C}_{1} \\ {C}_{2} \\ {C}_{3}\end{matrix} ) \qquad ( 8 )$$

where k₀ is the wavenumber in the cladding and κ₁(z) and κ₂(z) are z-dependent coupling coefficients obtained by multiplying z-independent constant coupling coefficients

$$\begin{matrix}\begin{matrix}{κ}_{1}^{( 0 )} = \frac{{ω}^{2}}{{c}^{2}} {\int }_{- ∞}^{∞} {Δϵ}_{1} ( x , y ) {Φ}_{1}^{( 0 )} ( x , y ) {Φ}_{3}^{( 0 )} ( x , y ) ⅆ x ⅆ y \\ and\end{matrix} & ( 9 ) \\ {κ}_{2}^{( 0 )} = \frac{{ω}^{2}}{{c}^{2}} {\int }_{- ∞}^{∞} {Δϵ}_{2} ( x , y ) {Φ}_{2}^{( 0 )} ( x , y ) {Φ}_{3}^{( 0 )} ( x , y ) ⅆ x ⅆ y & ( 10 )\end{matrix}$$

by the z-dependent envelope functions g₁(z) and g₂(z), respectively:

κ₁(z)=g₁(z)κ₁⁽⁰⁾ (11)

κ₂(z)=g₂(z)κ₂⁽⁰⁾ (12)

Equation (8) can be solved analytically. It can be shown that if κ₁(z) and κ₂(z) are such that

$$\begin{matrix}\begin{matrix}\frac{{k}_{0} \vert ⅆ ϑ / ⅆ z \vert}{\sqrt{{κ}_{1}^{2} ( z ) + {κ}_{2}^{2} ( z )}} \&LeftSkeleton; 1 \\ where\end{matrix} & ( 13 ) \\ ϑ ( z ) = arc tan ( \frac{{κ}_{1} ( z )}{{κ}_{2} ( z )} ) & ( 14 )\end{matrix}$$

then adiabatic power transfer between the optical modes is obtained. Moreover, if initially C₁(z=0)=1, C₂(z=0)=0 and C₃(z=0)=0, and κ₁(z) and κ₂(z) are such that κ₁(z=0)<<κ₂(z=0), then the coefficients of the optical modes are given by

$$\begin{matrix}{C}_{1} ( z ) = \frac{{κ}_{2} ( z )}{\sqrt{{κ}_{1}^{2} ( z ) + {κ}_{2}^{2} ( z )}} & ( 15 ) \\ {C}_{2} ( z ) = \frac{{κ}_{1} ( z )}{\sqrt{{κ}_{1}^{2} ( z ) + {κ}_{2}^{2} ( z )}} & ( 16 ) \\ {C}_{3} ( z ) = 0 & ( 17 )\end{matrix}$$

Finally, if κ₁(z) and κ₂(z) are such that κ₁(z=L)>>κ₂(z=L), where L is the length of the waveguide section in which the refractive index is modulated, then

|C₂(z=L)|²=1 (18)

Thus, the optical power initially carried by the optical mode Φ₁⁽⁰⁾(x,y) is transferred completely to the optical mode Φ₂⁽⁰⁾(x,y). Note that Φ₁⁽⁰⁾(x,y) and Φ₂⁽⁰⁾(x,y) are not coupled directly to each other and that each of them is coupled to the third optical mode Φ₃⁽⁰⁾(x,y) by κ₁(z) and κ₂(z), respectively. However, the third optical mode does not contribute to the optical field propagation, provided that the adiabatic condition is satisfied. Moreover, the adiabatic power transfer is obtained by a counterintuitive sequence of couplings κ₁(z) and κ₂(z). That is, in order to transfer optical power from the first optical mode to the second optical mode, the perturbation of the refractive index that couples the second and the third initially unpopulated optical modes (κ₂) must be introduced upstream of the perturbation that couples the initially populated first optical mode and the initially unpopulated third optical mode (κ₁). Both the adiabaticity of the optical mode coupling and the efficiency of the optical power transfer depend on the form of the optical mode coupling coefficients κ₁(z) and κ₂(z). From equation (13) and the boundary conditions κ₁(z=0)<<κ₂(z=0) and κ₁(z=L)>>κ₂(z=L) it follows that the z-dependent envelopes of the coupling coefficients must overlap, because the optical mode coupling strength between Φ₁⁽⁰⁾(x,y) and Φ₃⁽⁰⁾(x,y) increases with z, whereas the optical mode coupling strength between Φ₂⁽⁰⁾(x,y) and Φ₃⁽⁰⁾(x,y) decreases with z. The precise z-dependence of the coupling strengths is not important, provided that κ₁(z) and κ₂(z) vary sufficiently slowly with z to preserve adiabaticity.

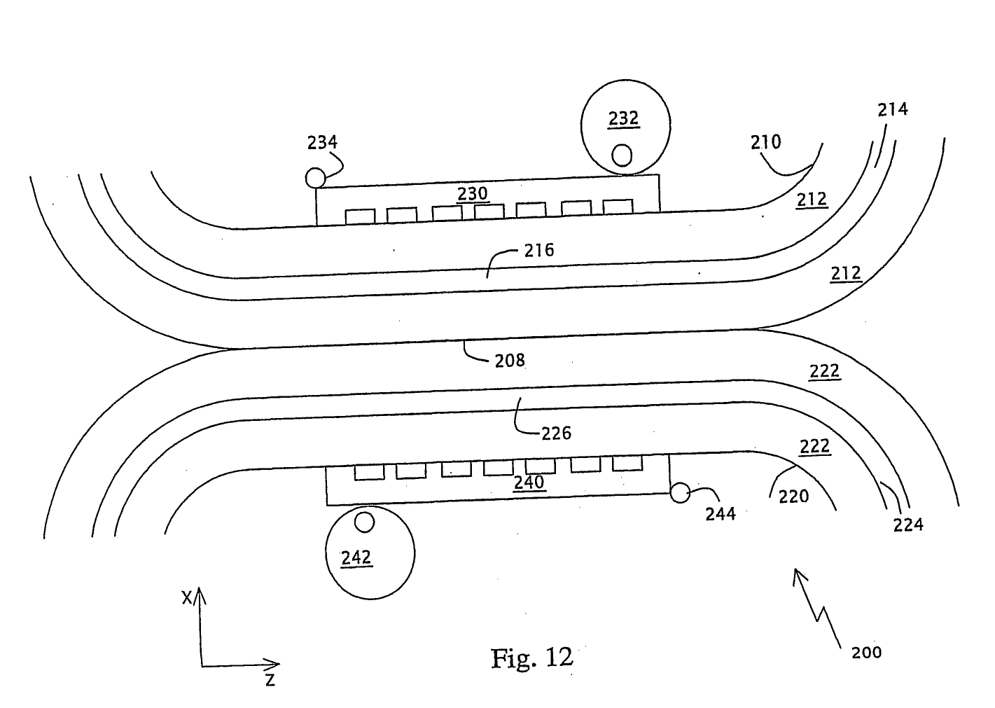

FIG. 12, which is adapted from FIG. 3 of Vorobeichik et al., is a schematic longitudinal cross-section of a directional coupler 200 of the second aspect of the present invention, for reversibly coupling two optical fibers 210 and 220. Optical fiber 210 includes a core 214 encased in a cladding 212. Similarly, optical fiber 220 includes a core 224 encased in a cladding 222. Claddings 212 and 222 are in contact along a boundary 208. The parallel portions of cores 214 and 224 adjacent to boundary 208 constitute coupling sections 216 and 226. Cores 214 and 224 have indices of refraction that are larger than the indices of refraction of claddings 212 and 222, so that cores 214 and 224 and the immediately adjacent portions of claddings 212 and 222 constitute waveguides, analogous to waveguides 12 and 14 of planar waveguide structure 10, with respective effective indices of refraction; and the portions of claddings 212 and 222 between coupling sections 216 and 226 constitute a coupling region, analogous to coupling region 16 of planar waveguide structure 10, with a respective effective index of refraction that is lower than the effective indices of refraction of the waveguides. Also shown in FIG. 12 are coordinate axes x (transverse) and z (longitudinal).

On opposite sides of optical fibers 210 and 220, parallel to coupling sections 216 and 226, are planar gratings 230 and 240, and cams 232 and 242 that, when rotated, cause their respective planar gratings 230 and 240 to pivot on respective hinges 234 and 244. In the illustrated positions of cams 232 and 242, optical fibers 210 and 220 are unstressed, and the indices of refraction of coupling sections 216 and 226 are longitudinally homogeneous, as are the effective indices of refraction of the corresponding waveguides. By rotating cams 232 and 242, longitudinal periodic stress fields are imposed on optical fibers 210 and 220, thereby perturbing the indices of refraction of coupling sections 216 and 218, and hence the effective indices of refraction of the equivalent waveguides, in a quasiperiodic manner. By a “quasiperiodic” perturbation is meant a periodic perturbation with a laterally non-uniform envelope function, so that the peak (maximum and minimum) amplitudes of the perturbation have different values in different cycles or periods of the perturbation In particular, the envelope function of the stress field imposed on optical fiber 210 by planar grating 230, and hence the envelope function of the perturbation induced in the indices of refraction of optical fiber 210 and in the effective index of refraction of the equivalent waveguide by planar grating 230, increases monotonically in the e direction; whereas the envelope function of the stress field imposed on optical fiber 220 by planar grating 240, and hence the envelope function of the perturbation induced in the indices of refraction of optical fiber 220 and in the effective index of refraction of the equivalent waveguide by planar grating 240, decreases monotonically in the +z direction. As a result, by the principles of the second aspect of the present invention, light that propagates in the +z direction in optical fiber 210 is coupled by these perturbations into optical fiber 220. Directional coupler 200 thus functions as a normally “off” optical switch. When cams 232 and 242 are in the positions shown in FIG. 12, so that no stress fields are imposed on optical fibers 210 and 220, light propagating in the +z direction via optical fiber 210 remains in optical fiber 210. When cams 232 and 242 are rotated to urge planar gratings 230 and 240 towards optical fibers 210 and 220, thereby imposing their respective stress fields on optical fibers 210 and 220, at least part of the light that propagates in the +z direction via optical fiber 210 is coupled into optical fiber 220, to propagate in the +z direction via optical fiber 220.

Planar gratings 230 and 240, and their associated cams 232 and 242 and pivots 234 and 244, constitute mechanical mechanisms for reversibly inducing quasiperiodic perturbations in the indices of refraction of optical fibers 210 and 220, and so in the effective indices of refraction of the equivalent waveguides, according to the principles of the second aspect of the present invention. It will be apparent to those skilled in the art that other types of mechanisms, for example thermo-optic mechanisms, piezo-electric mechanisms, acousto-optic mechanisms, electro-optic mechanisms and mechanisms that reversibly inject charge carriers into optical fibers 210 and 220, also may be used.

While the invention has been described with respect to a limited number of embodiments, it will be appreciated that many variations, modifications and other applications of the invention may be made.

What is claimed is:

1. A waveguide structure comprising:
(a) a first waveguide, having a proximal end, and having a first waveguide effective index of refraction \overline{n}₁;
(b) a second waveguide, substantially parallel to said first waveguide, having a proximal end, and having a second waveguide effective index of refraction \overline{n}₂;
(c) a coupling region, situated between said waveguides, having a coupling region effective index of refraction \overline{n}₃ that is less than \overline{n}₁ and that also is less than \overline{n}₂;
(d) a first bounding region, said first waveguide being situated between said first bounding region and said coupling region, said first bounding region having a proximal end adjacent to said proximal end of said first waveguide, said first bounding region having a first bounding region effective index of refraction that decreases adiabatically, in a direction substantially parallel to said waveguides, from a value, at said proximal end of said first bounding region, that is between \overline{n}₁ and \overline{n}₃, to an intermediate value, in a switching section of said first bounding region, that is less than \overline{n}₃; and
(e) a second bounding region, said second waveguide being situated between said second bounding region and said coupling region, said second bounding region having a proximal end adjacent to said proximal end of said second waveguide, said second bounding region having a second bounding region effective index of refraction that decreases adiabatically, in said substantially parallel direction, from a value, at said proximal end of said second bounding region, that is between \overline{n}₂ and \overline{n}₃, to an intermediate value, in a switching section of said second bounding region, that is less than \overline{n}₃.

2. The waveguide structure of claim 1, wherein said first and second waveguides have respective distal ends, wherein said first bounding region has a distal end adjacent to said distal end of said first waveguide, wherein said second bounding region has a distal end adjacent to said distal end of said second waveguide, wherein said first bounding region effective index of refraction increases adiabatically, in said substantially parallel direction, from said intermediate value thereof, in said switching section of said first bounding region, to a value, at said distal end of said first bounding region, that is between \overline{n}₁ and \overline{n}₃, and wherein said second bounding region effective index of refraction increases adiabatically, in said substantially parallel direction, from said intermediate value thereof, in said switching section of said second bounding region, to a value, at said distal end of said second bounding region, that is between \overline{n}₂ and \overline{n}₃.

3. The waveguide structure of claim 1, wherein said intermediate values are substantially equal.

4. The waveguide structure of claim 1, wherein said waveguides meander transversely to said parallel direction between said switching sections of said bounding regions.

5. The waveguide structure of claim 4, wherein said meandering is substantially in a plane defined by said waveguides.

6. The waveguide structure of claim 4, wherein said meandering is substantially perpendicular to a plane defined by said waveguides.

7. The waveguide structure of claim 4, wherein said meandering couples respective optical modes of said waveguides, that are substantially confined to said waveguides, to a high-order optical mode common to both said waveguides.

8. The waveguide structure of claim 7, wherein said respective optical modes of said waveguides are zero-order optical modes of said waveguides.

9. The waveguide structure of claim 1, wherein respective thicknesses of said waveguides vary substantially periodically in said parallel direction between said switching sections of said bounding regions.

10. The waveguide structure of claim 9, wherein said varying of said thicknesses is substantially in a plane defined by said waveguides.

11. The waveguide structure of claim 9, wherein said varying of said thicknesses is substantially perpendicular to a plane defined by said waveguides.

12. The waveguide structure of claim 9, wherein said varying of said thicknesses couples respective optical modes of said waveguides, that are substantially confined to said waveguides, to a high-order optical mode common to both said waveguides.

13. The waveguide structure of claim 12, wherein said respective optical modes of said waveguides are zero-order optical modes of said waveguides.

14. The waveguide structure of claim 1, further comprising:
(f) a mechanism for reversibly perturbing, in and between said switching sections, at least one effective index of refraction selected from the group consisting of said bounding region effective indices of refraction, \overline{n}₁, \overline{n}₂ and \overline{n}₃.

15. The waveguide structure of claim 14, wherein said perturbation is substantially uniform in said substantially parallel direction.

16. The waveguide structure of claim 14, wherein said perturbation is substantially periodic in said substantially parallel direction.

17. The waveguide structure of claim 14, wherein said mechanism is thermo-optic.

18. The waveguide structure of claim 14, wherein said mechanism is piezo-electric.

19. The waveguide structure of claim 14, wherein said mechanism is acousto-optic.

20. The waveguide structure of claim 14, wherein said mechanism is electro-optic.

21. The waveguide structure of claim 14, wherein said mechanism is operative to inject charge carriers reversibly into at least one portion of the waveguide structure selected from the group consisting of said waveguides, said bounding regions and said coupling region.

22. A directional coupler comprising the waveguide structure of claim 14.

23. A power divider comprising the directional coupler of claim 22.

24. A wavelength filter comprising the directional coupler of claim 22.

25. An optical modulator comprising the directional coupler of claim 22.

26. An attenuator comprising the directional coupler of claim 22.

27. An optical switch comprising the waveguide structure of claim 14.

28. An optical switch matrix comprising at least one optical switch of claim 27.

29. An optical switch matrix, for switching optical signals from a first number of input waveguides to a second number of output waveguides, a larger of said two numbers being greater than 2, the optical switch matrix comprising:
(a) a plurality of switch waveguides, equal in number to the larger of said two numbers, each said switch waveguide being optically coupled to at least one of a respective input waveguide and a respective output waveguide, all said switch waveguides being substantially straight and parallel.

30. The optical switch matrix of claim 29, further comprising:
(b) for each adjacent pair of said switch waveguides, at least one coupling mechanism for optically coupling said each adjacent pair of switch waveguides.

31. The optical switch matrix of claim 30, wherein for each adjacent pair of said switch waveguides, each said coupling mechanism includes:
(i) a coupling region, between at least a portion of a first of said switch waveguides of said each adjacent pair and at least a portion of a second of said switch waveguides of said each adjacent pair, said at least portion of said first switch waveguide having a first waveguide effective index of refraction \overline{n}₁, said at least portion of said second switch waveguide having a second waveguide effective index of refraction \overline{n}₂, said coupling region having a coupling region effective index of refraction \overline{n}₃ that is less than \overline{n}₁ and that also is less than \overline{n}₂.

32. The optical switch matrix of claim 31, wherein, for each said coupling region, said at least portions of said first and second switch waveguides have respective proximal ends; and wherein each said coupling mechanism further includes:
(d) a first bounding region, said at least portion of said first switch waveguide being situated between said first bounding region and said coupling region, said first bounding region having a proximal end adjacent to said proximal end of said at least portion of said first switch waveguide, said first bounding region having a first bounding region effective index of refraction that decreases adiabatically, in a direction substantially parallel to said switch waveguides, from a value, at said proximal end of said first bounding region, that is between \overline{n}₁ and \overline{n}₃, to an intermediate value, in a switching section of said first bounding region, that is less than \overline{n}₃; and
(e) a second bounding region, said at least portion of said second switch waveguide being situated between said second bounding region and said coupling region, said second bounding region having a proximal end adjacent to said proximal end of said at least portion of said second switch waveguide, said second bounding region having a second bounding region effective index of refraction that decreases adiabatically, in said substantially parallel direction, from a value, at said proximal end of said second bounding region, that is between \overline{n}₂ and \overline{n}₃, to an intermediate value, in a switching section of said second bounding region, that is less than \overline{n}₃.

33. The optical switch matrix of claim 32, wherein, for each said coupling region: said at least portions of said first and second switch waveguides have respective distal ends, wherein said first bounding region has a distal end adjacent to said distal end of said at least portion of said first switch waveguide, wherein said second bounding region has a distal end adjacent to said distal end of said at least portion of said second switch waveguide, wherein said first bounding region effective index of refraction increases adiabatically, in said substantially parallel direction, from said intermediate value thereof, in said switching section of said first bounding region, to a value, at said distal end of said first bounding region, that is between \overline{n}₁ and \overline{n}₃, and wherein said second bounding region effective index of refraction increases adiabatically, in said substantially parallel direction, from said intermediate value thereof, in said switching section of said second bounding region, to a value, at said distal end of said second bounding region, that is between \overline{n}₂ and \overline{n}₃.

34. A directional coupler, comprising:
(a) a first waveguide having a first effective index of refraction;
(b) a second waveguide, substantially parallel to said first waveguide and having a second effective index of refraction;
(c) a first mechanism for reversibly inducing a first quasiperiodic perturbation in said first effective index of refraction; and
(d) a second mechanism for reversibly inducing a second quasiperiodic perturbation in said second effective index of refraction;
wherein said first quasiperiodic perturbation has a first envelope function that varies monotonically along said first waveguide, and wherein said second quasiperiodic perturbation has a second envelope function that varies monotonically along said second waveguide in a sense opposite to said variation of said first envelope function.

35. The directional coupler of claim 34, further comprising:
(e) a coupling region situated between said first and second waveguides and having a third effective index of refraction that is less than both said first effective index of refraction and said second effective index of refraction;

36. The directional coupler of claim 34, wherein said waveguides are single-mode waveguides.

37. The directional coupler of claim 34, wherein said mechanisms are thermo-optic.

38. The directional coupler of claim 34, wherein said mechanisms are piezo-electric.

39. The directional coupler of claim 34, wherein said mechanisms are acousto-optic.

40. The directional coupler of claim 34, wherein said mechanisms are electro-optic.

41. The directional coupler of claim 34, wherein said first and second mechanisms are operative to inject charge carriers reversibly into said first waveguide and into said second waveguide, respectively.

42. A power divider comprising the directional coupler of claim 34.

43. A wavelength filter comprising the directional coupler of claim 34.

44. An optical switch comprising the directional coupler of claim 34.

45. An optical modulator comprising the directional coupler of claim 34.

46. An attenuator comprising the directional coupler of claim 34.

47. A method for diverting a least a portion of electromagnetic energy, that propagates in a certain direction via a first waveguide, to a second waveguide that is substantially parallel to the first waveguide, comprising the steps of:
(a) inducing a first quasiperiodic perturbation in an effective index of refraction of the first waveguide, said first perturbation having an envelope function that varies monotonically in the propagation direction; and
(b) inducing a second quasiperiodic perturbation in an effective index of refraction of the second waveguide, said second perturbation having an envelope function that varies monotonically in the propagation direction in a sense opposite to said variation of said envelope function of said first perturbation.

48. The method of claim 47, wherein said envelope function of said first perturbation increases in the propagation direction and wherein said envelope function of said second perturbation decreases in the propagation direction.
